(19) United States
(12) Patent Application Publication
(10) Pub. No.: US 2012/0011359 A1
(43) Pub. Date: Jan. 12, 2012

(54) Mobile intellectual property protection apparatus and methodology

(75) Inventor: Young H. Etheridge, Oak Ridge, TN (US)

(73) Assignee: Zenerji LLC, Naples, FL (US)

(21) Appl. No.: 12/929,030

(22) Filed: Dec. 22, 2010

Related U.S. Application Data
(60) Provisional application No. 61/344,372, filed on Jul. 8, 2010.

(51) Int. Cl. G06F 21/24

(52) U.S. Cl. 713/165

(57) ABSTRACT

A mobile intellectual property protection apparatus and methodology maintains digitally recorded IP-related evidence using cryptographic techniques to definitively and securely maintain the secrecy of a digitally recorded evidence of an intellectual property by immediately establishing a tamper-proof time-stamp of the temporal existence of the recorded evidence. The digitally recorded intellectual property is designed to serve as a digital expert witness to assist in establishing, for example, the conception of an invention or other legal claims.

This application claims the benefit under 35 U.S.C. 119(e) of Provisional Application No. 61/344,372, filed Jul. 8, 2010, the entire contents of which is hereby incorporated by reference in this application.

### FIELD

The illustrative implementations relate to intellectual property and/or work-product protection apparatus and methodology that use cryptographic techniques to securely maintain the secrecy of digitally recorded intellectual property-related evidence. More particularly, the illustrative implementations relate to a mobile intellectual property protection apparatus and methodology that manages digitally recorded intellectual property-related evidence by immediately establishing a tamper-proof time-stamp of the temporal existence of the recorded evidence.

### BACKGROUND AND SUMMARY

Well prior to the invention of the automobile, the telephone, and the light bulb, inventors have been concerned with how to appropriately preserve in secrecy and document the conception of an invention. Even today, many inventors fail to document a conceived invention until months after an idea has blossomed from a general idea for accomplishing a desired result to concrete, enabling methodology for solving a particular problem.

For decades many corporations have required engineers and scientists to carefully document their work product in inventor notebooks. Some corporate inventor's notebooks are meticulously maintained and carefully witnessed by colleagues of an inventor. Other corporate inventor's notebooks document product developments on a haphazard basis with inappropriately witnessed new designs.

Before the advent of the illustrative implementations, if a typical user familiar with digital time stamp technology desired to memorialize a document evidencing a newly conceived idea, there typically would be a need to write an application that conformed to an application programming interface to calculate a message imprint of a single file to request a time-stamp from a trusted time-stamp service that only partially captured evidence of the temporal existence of an intellectual property.

In accordance with illustrative implementations described herein, the digital computing assets offered by a personal mobile computer system are utilized to capture in toto all evidence of the temporal existence of newly conceived “intellectual property” (used herein to broadly refer to creations of the mind such as, for example, to a partially or fully conceived idea/invention).

The digitally recorded intellectual property is designed to serve as a digital expert witness to assist in establishing, for example, the conception of an invention or other legal claims. Illustrative implementations can cryptographically bind a registered digital identity(s). Furthermore, illustrative implementations can cryptographically bind the intellectual property to the physical location of the intellectual property at the moment of establishing its temporal existence. Exposure and subsequent loss of secrecy of the intellectual property is mitigated by performing the generation of the digital “expert witness” of the intellectual property on the local device whereupon the intellectual property is captured.

For example, illustrative implementations contemplate immediately capturing a handwritten or spoken idea, cryptographically binding it with existing laboratory data or a signed contract or any other information which corroborates a handwritten idea. An especially fertile inventor who has “bright ideas” at unscheduled moments will be able to use the methodology/apparatus described herein to digitally, capture and expertly witness the temporal existence of all of the digital facsimiles associated with an intellectual property, immediately without the danger of another laying effective claim to the same invention. Furthermore, an illustrative implementation allows identification attributes and location attributes to be cryptographically bound to the time the temporal existence of the intellectual property is established.

The personal mobile computer system may include, for example, a smart-phone, with its enhanced media devices as well as its “always connected” capability provides a ready mechanism for protecting intellectual property during the early moments of conception. The smart-phone is a non-limiting example of a personal mobile computer device/system in accordance with an illustrative implementation. Other devices such as tablet devices, net-books, and laptops can equally well be considered personal mobile computer devices/systems. Generally, personal mobile computer systems typically possess keyboard edit capability for digital information recording. Frequently, these devices contain virtual keyboards whereby typed digital information can be recorded via touch-screen virtual keyboards. Many of these devices also possess physical keyboards whereby typed digital information can be recorded. Furthermore, these personal mobile computer systems usually possess high quality digital cameras which can produce still frame photographs. Such personal mobile computer systems also can generally produce high-quality audio recordings. These devices frequently possess the capability to encode and/or decode (codec) a digital data stream for capturing high-quality video recordings. Singularly or together, these capabilities permit the creation of a digital facsimile of intellectual property that has been type-written, hand drawn using touch screen input, traditionally hand-written then digitally recorded via the still-frame camera or via orally described and/or video-recorded during an explanatory “chalk talk”.

Furthermore, the computing power of these personal mobile computing systems is fast becoming more than adequate to perform the necessary processing-intensive computations that can securely produce cryptographic qualities that are known to protect information. Significantly, many of the newest personal mobile computers use processors which have embedded security processing power for performing cryptographic functionality, such as message digests or hash functions, random number generation, and public key cryptography.

Personal mobile computing systems generally have access to extensive software markets which supply applications, commonly called apps, which capture and manage information that may well be considered to be digital intellectual property that needs to be properly protected. However, such digital information is not typically digitally witnessed for temporal existence in the manner offered by the illustrative implementations. Illustrative implementations are designed to let these apps take advantage of the power of the personal mobile computing system to immediately become an input resource to the digital expert witness capacity of such illustrative implementations to protect the digital information as expertly witnessed digital intellectual property.

The “always connected” nature of a personal mobile computer provides the immediacy whereby digital expert witnessing may be effectively achieved. This connectedness is produced by the inclusion of multiple radio devices. These devices allow the personal mobile computer to communicate over various protocols, including: Wi-Fi and/or cellular telephonic connectivity (3G/4G, CDMA, GSM, etc.).

A system and method for immediate intellectual property recordation/protection is realized in an illustrative, non-limiting implementation by using mobile computing device(s) to:
1. Produce digital evidence of a digital facsimile of intellectual property by using the media devices on a personal mobile computing device. The device keyboard, virtual or real, digitally records keyed input relating to intellectual property. Likewise, the touch screen allows the user to generate rough draft drawings and notes that can be used as a digital record relating to intellectual property. The digital camera records visual digital evidence. The digital voice recorder digitally captures, for example, oral conception and/or reduction to practice evidence. The digital video recorder digitally captures synchronized visual and oral evidence. These captured digital evidences are cryptographically bound to each other as a unitized digital facsimile of the intellectual property.
2. Record the digital facsimile input(s) of the intellectual property on the mobile device to maintain secrecy by the manager of the mobile device but be recallable for posterity.
3. Calculate the cryptographic imprint of the digitally recorded intellectual property using mathematically sound cryptographic message digest function(s).
4. Produce one or more significant attributes as associated extensions of the digitally recorded intellectual property to be cryptographically bound in the above cryptographic imprint. These significant extension attributes would, for example, minimally be registered identity(s) to be associated with a subsequently requested time-stamp. Other extension attributes could be the location of the personal mobile computing device as offered by a GPS unit that in the illustrative implementation is present in the personal mobile computing device used herein or by other means such as radiolocation by a cellular network using triangulation among radio towers, or Wi-Fi based location technology.
5. Using the digital communication device(s) in the personal mobile computing device that captured the digital facsimile of an intellectual property, generate a service request for a standardized, cryptographic time-stamp from a time-stamp service provider using the above cryptographic imprint with the cryptographically bound extension attribute(s), for example, the registered identity(s) attribute. Typical time-stamp service providers do not require access to the original content being time-stamped, thereby maintain the secrecy of the content.
6. Using the digital communication device(s) in the mobile computing device that captured the intellectual property facsimile, receive from the time-stamp service provider the cryptographic time-stamp with the cryptographically bound encoded identity as a result of the above request.
7. Record the received time-stamp on the personal mobile device.
8. Relate the received time-stamp to the digital facsimile of the previously-saved intellectual property for convenient reuse.
9. Securely communicate to a service that will manage the digital facsimile of the intellectual property and manage its associated time-stamp. If desired, this service would assure the privacy of the digital facsimile of the intellectual property while maintaining its unique association to the cryptographic time-stamp.

A cryptographic imprint is a composition of one or more cryptographic message digests which have been each applied to the digital facsimile of the captured intellectual property. Multiple message digests in a cryptographic imprint is a feature of the standards for cryptographic time-stamps. Multiple message digests, using differing message digest functions, are often used in order to increase the resilience of the calculated cryptographic imprint. If, for example, one of the component message digests becomes cryptographically weak the alternate component message digest(s) will provide assurances of the cryptographic efficacy of the message imprint of the digitally captured intellectual property. Well-known examples of cryptographic message digests or hash functions include: MD4, MD5, SHA-128, SHA-256, SHA-384, SHA-512, RIPEMD-128, RIPEMD-160, RIPEMD-256, RIPEMD-320, or WHIRLPOOL. The National Institute of Standards and Technology (NIST) has opened a public competition for a new message digest function (hash algorithm) called SHA-3. Once this competition has run its course, a new, cryptographically secure message digest will be available for consideration. The purpose of the new message digest is to offer a publicly usable replacement digest in the event that present day message digests become subject to being cryptographically unsound. In any event, the use of a cryptographic imprint provides a cryptographic resilience that may not be evident with a single hash algorithm. Accepted cryptographic standard properties of the cryptographic imprint include:
Each composite message digest function necessary for determining the cryptographic imprint of the digital facsimile of the intellectual property can be cryptographically bound to the operating system that is used to manage the personal mobile computing device to be assured that a known, acceptable version of a message digest function is used.
Each composite message digest has been tested to demonstrate that it possesses validation properties of well-know test vectors in order that the validity of the cryptographic imprint can be proven by an independent expert witness.
It is relatively simple for the mobile device to securely compute the message digest value associated with the cryptographic imprint for any given digital facsimile of an intellectual property.
It is cryptographically infeasible to find any recorded information that has a given cryptographic imprint value.
It is cryptographically infeasible to modify the captured intellectual property without changing its associated cryptographic imprint value.
It is cryptographically infeasible to find two different recorded intellectual properties with the same cryptographic imprint value.
The calculation of the cryptographic imprint is performed internally to the PMCS without the digital facsimile of the intellectual property ever leaving the PMCS, thereby guarding the secrecy of the intellectual property.

In accordance with illustrative implementations, cryptographically binding digitally recorded intellectual property attribute extensions with the digital facsimile of an intellectual property utilizes the subsequently calculated cryptographic imprint toward providing answers to:
“who is to be identified as the individual(s) to have requested the evidence of the temporal existence of an intellectual property?”. One of these identities should be the identity used to access the account which is used for requesting the evidence of the temporal existence from the time-stamp authority's service.
“who is to be identified as the individual(s) associated with the ownership of an intellectual property at the event of requesting evidence of its temporal existence?”.
“who is to be identified as the individual(s) associated with the invention of an intellectual property at the request for the evidence of its temporal existence?”
“where was the physical location of the request for the evidence of the temporal existence of an intellectual property?”.

The question of “when was the request for the evidence generated for the proof of the temporal existence of a digital facsimile of intellectual property?” is answered and cryptographically bound by the properties of the standards-based Time-Stamp without need of additional attribute extensions. Typical standards-based time-stamp services offer assurances that their source of time is generally based on an official time source that is accurate and always advancing. The cryptological importance of the standardized time-stamp is dependent on the positive advancement of the time source.

Binding identity attributes as an integral part of the digital expert witness of an intellectual property is useful information especially under jurisprudential considerations. There is an on-going attempt to produce a standardized means of establishing a unique and cohesive persona to supplant the numerous identities with which users are known on their use of the Internet. OpenId is one such suggested mechanism for establishing and registering a unique and cohesive persona. Encoding such a registered identity as an intellectual property attribute extension provides a less confusing means of digitally associating an individual as one who is responsible for initiating the request for cryptographic evidence of an intellectual property. Association of identities to an individual is not simple. Ultimately accepting an identity, even a registered identity, to associate with an individual is fraught with issues which may require jurisprudential resolution. Cryptographically binding an identity(s) to an intellectual property is used to definitively establish named identities that are associated with the players involved in the production of the intellectual property. Cryptographically binding an identity(s) to the evidence of the temporal existence of a digital intellectual property provides a mathematical certitude of the identities of those associated with producing the intellectual property.

As suggested above adding the location of the captured intellectual property as an attribute extension is a useful option in this illustrative implementation. Knowing where an intellectual property may have been generated adds some credibility to the identity attributes bound to the intellectual property. Such information may well be quite useful in an investigation into the jurisdiction, production and ownership of the intellectual property. Furthermore, using the radio-location coordinates provided by the integral GPS of the personal mobile computing system or cellular network triangulation techniques then encoding using standards-based techniques enhances the simplicity of managing the location attribute. The IETF RFC-3863 for managing the “Presence Information Data Format (PIDF)” is an example of a valuable and common encoding method.

Low-power, reduced instruction set computer technology is producing qualified personal mobile computing devices with integrated circuitry which offer at least one high-quality digital camera, high-fidelity audio recording, good video camera recorders, as well as cellular telephone connectivity and in many cases alternative, high-speed Wi-Fi connectivity. The following short list of such devices suggests that this methodology is readily implementable in an expanding variety of forms:
Smart-phones and tablets using the Android Operating System are offered as the Motorola Droid, Motorola Droid 2, Motorola Droid X, HTC Droid Incredible, Google Nexus One, T-Mobile G1, Samsung Galaxy Tab, Sprint HTC EVO 4G, and Cisco Cius;
Apple's smart-phones and tablets are demonstrated by the popular iPhone 3G, iPhone-3GS, iPhone-4, iPad with Wi-Fi+3G;
Smart-phones based on Microsoft's Windows Phone 7 (WP7) such as Samsung's Omnia for WP7;
Smart-phones based on Nokia's Maemo software as offered via the N900;
And, Smart-phones based on Palm's WebOS such as the Palm Pre Plus.

Each of the above devices has software development capabilities for producing an implementation of this methodology. These devices have demonstrated the capability of being efficiently programmable with an object-oriented programming language such as Java, Objective-C, C++ or C#, as well as user-interface software development kits (SDK) that simplify and standardize enhanced event management and device management.

In non-limiting illustrative, exemplary implementations, the time-stamp service to which a user subscribes for generation of the standardized time-stamp should possess a number of capabilities in order to illustratively achieve the objectives of exemplary implementations. This non-limiting, illustrative, exemplary set comprises the following preferred features:
The generated time-stamp is issued from a trustworthy time-stamp authority whose time originates from a trustworthy source whereby time is assured of advancing in perpetuity. For example, the Network Time Protocol (NTP) service provided by the National Institutes of Standards and Technology (NIST) offers such a service.
The generated time stamp be irrefutably verifiable.
The time-stamp service generates a time-stamp based on industry accepted standards and properties that include:
   ASN.1 encoded digital time-stamp token using ANSI X9.95, ISO/IEC 18014-1, ISO/IEC 18014-2, ISO/IEC 18014-3, and IETF RFC-3161 to establish the preferred embodiment of the time-stamp (TSTInfo ASN.1 structure as equivalently specified in each of the preferred standards).
   The time-stamp service be able to issue a renewal of a requested time-stamp in the event that the cryptographic imprint of the digital facsimile of the recorded intellectual property become cryptographically unsound, for example, if the reliability of the cryptographic hash algorithm were called into question due to advancements in message digest cryptanalysis. The renewed time-stamp will cryptographically bind the original time-stamp to itself.
   The time-stamp service be accessible using a communication protocol that complies with those established by accepted industry standards, for example, the HTTP/HTTPS protocols.
The generated time-stamp have a long life span whereby it is valid throughout the useful life span of the intellectual property.
The validity of the generated time-stamp can be determined independently of the generating time-stamp service, using openly validated software.

Commercial time-stamp services are accessible to an appropriately programmed personal mobile computing device using typical Internet access protocols. A short list of such services include:
Bry Technology;
e-TimeStamp;
GlobalTrustFinder;
Guardtime;
Surety, LLC;

### BRIEF DESCRIPTION OF THE DRAWINGS

These and other features and advantages of the illustrative embodiments described herein will become apparent with reference to the following drawings and accompanying specification.

FIG. 1 depicts an inventor giving a chalk talk about an inventive concept that may be cryptographically memorialized and protected via the methodology described herein.

FIG. 2 is an illustrative block diagram of a personal mobile computing system for use in an illustrative implementation.

FIG. 3 is an illustrative diagram of the network services for use in an illustrative implementation.

FIGS. 4a and 4b are illustrative flow diagrams depicting the sequence of operations of an illustrative IPWitness application.

FIG. 5 is an illustrative flow diagram depicting the sequence of operations involved in the IPViewAndStore functionality.

### ILLUSTRATIVE IMPLEMENTATIONS

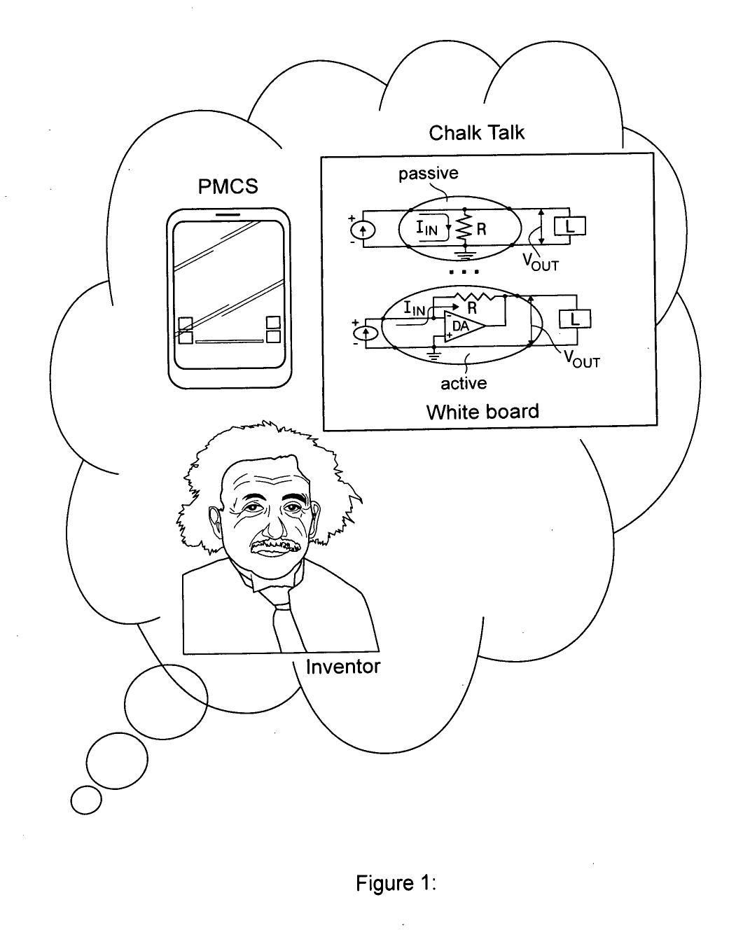

FIG. 1 depicts an inventor giving a chalk talk about an inventive concept that may be cryptographically memorialized and protected via the methodology described herein. Presume that the inventor shown in FIG. 1 has just conceived of an invention, e.g., a novel circuit, figuratively represented by the electrical components shown on the white board. The inventor is concerned with providing proof of his conception to aid in precluding another from pirating his work that may have been the culmination of years of research. As will be appreciated the invention need not be a circuit, but may be a possibly novel and non-obvious chemical composition, process, computer software, etc.

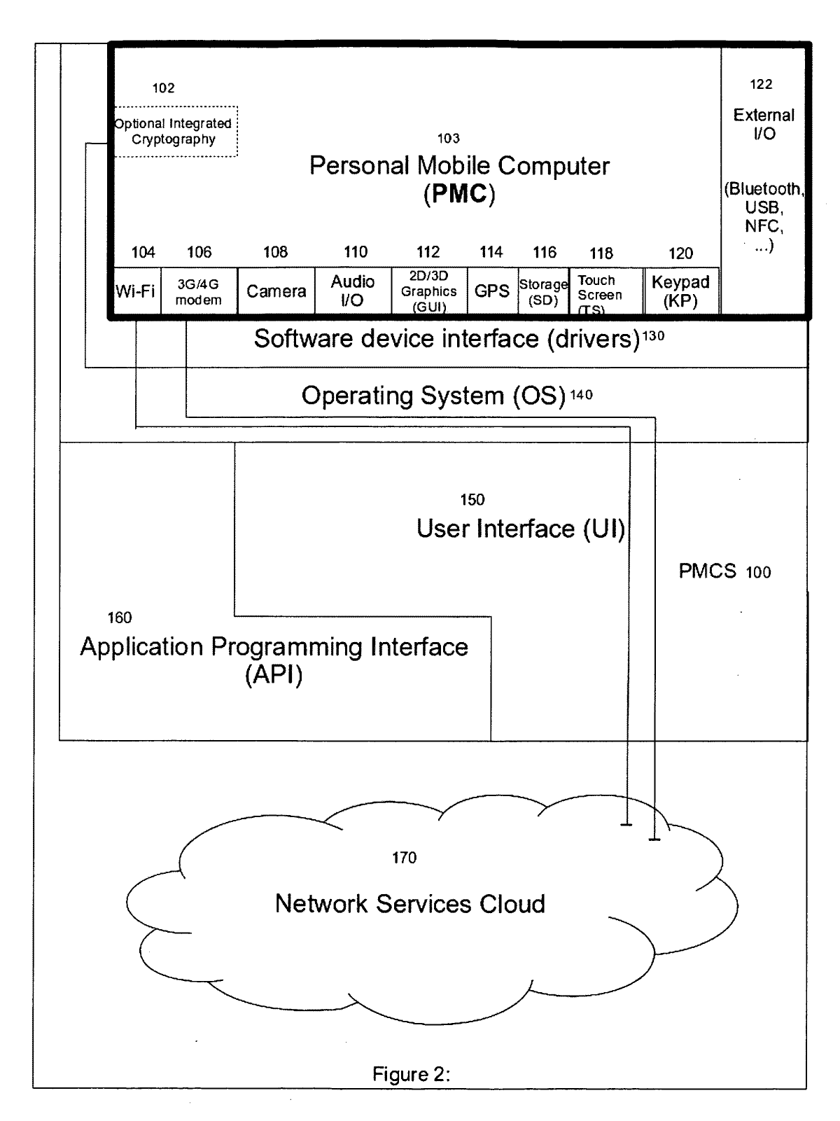

The inventor begins his protection process by running an application in accordance with an illustrative implementation referred to as IPWitness, on his personal mobile computing system (hereinafter, PMCS) device such as that shown in illustrative FIG. 2 that is described further below.

In this example, the inventor initially configures his PMCS application to audio record his oral “chalk-talk” as he writes his new ideas on his favorite medium for documenting and explaining his ideas, e.g., a white board, either by himself or to a colleague. While diagrams, key words, and concepts are written on the white board, the inventor verbalizes and further explains his new ideas.

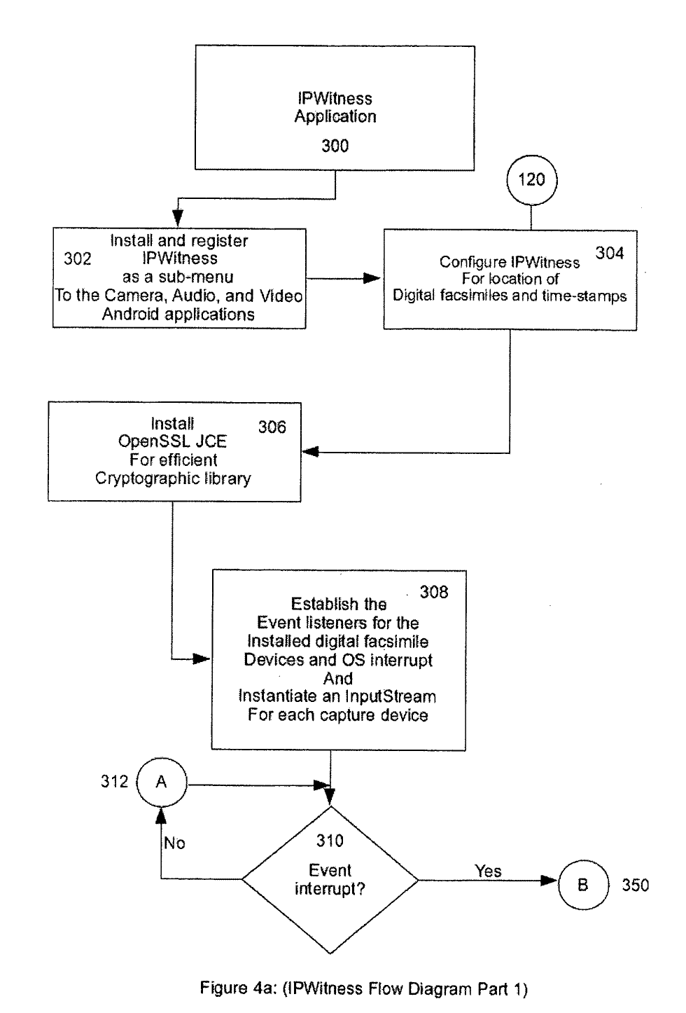

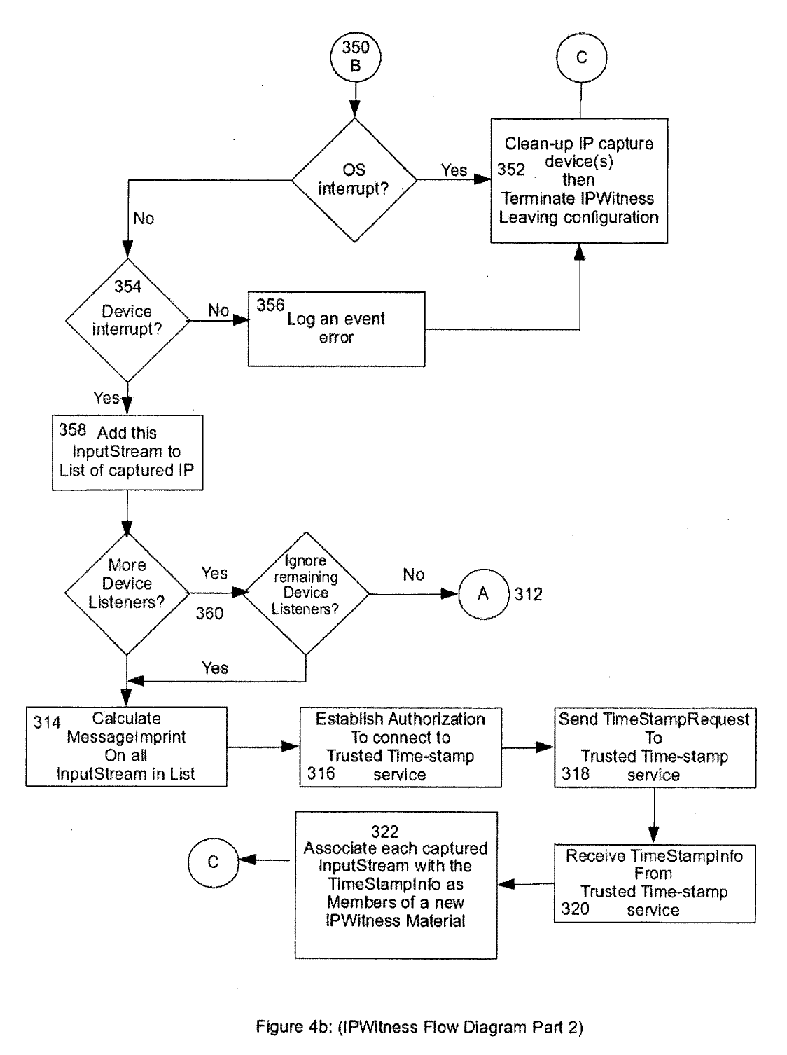

In accordance with the methodology set forth in FIGS. 4a and 4b, in this example, once the inventor has completed his chalk-talk, he completes the oral description of the “chalk-talk” whereby the PMCS digitally saves the recorded oral “chalk-talk”. The inventor then uses the integrated camera 108 on his PMCS shown in FIG. 2 to generate a digital photograph of the material that he wrote on the white-board. If the inventor generated the chalk-talk from the library of his home in Hoboken, N.J., the inventor uses the GPS unit 114 on his PMCS shown in FIG. 2 to create the location attributes of the “chalk-talk” as being that of the library of his house. Furthermore, the inventor generates (using the subject IPWitness application of an illustrative implementation) an identification attribute using his OpenId, johnqinventor@gmail.com, to identify himself as the inventor and owner of the new idea.

The inventor's PMCS executing IPWitness in an illustrative implementation then collects the digital audio recording, the digital photograph, the location attribute, and the identity attributes into an IPWitness binding zip file-system for convenience. In this example, at substantially the same time, each of these collected components is streamed as input to a MessageImprint function on the PMCS. This particular MessageImprint may be configured to calculate the 512-bit SHA message digest as well as the RipeMD 160 bit message digest of this collection of digital intellectual-property and the attributes. Once this MessageImprint is generated it is bound in the standardized Time-Stamp Request as described in the ANSI X9.95-2005, Trusted Time Stamp Management and Security.

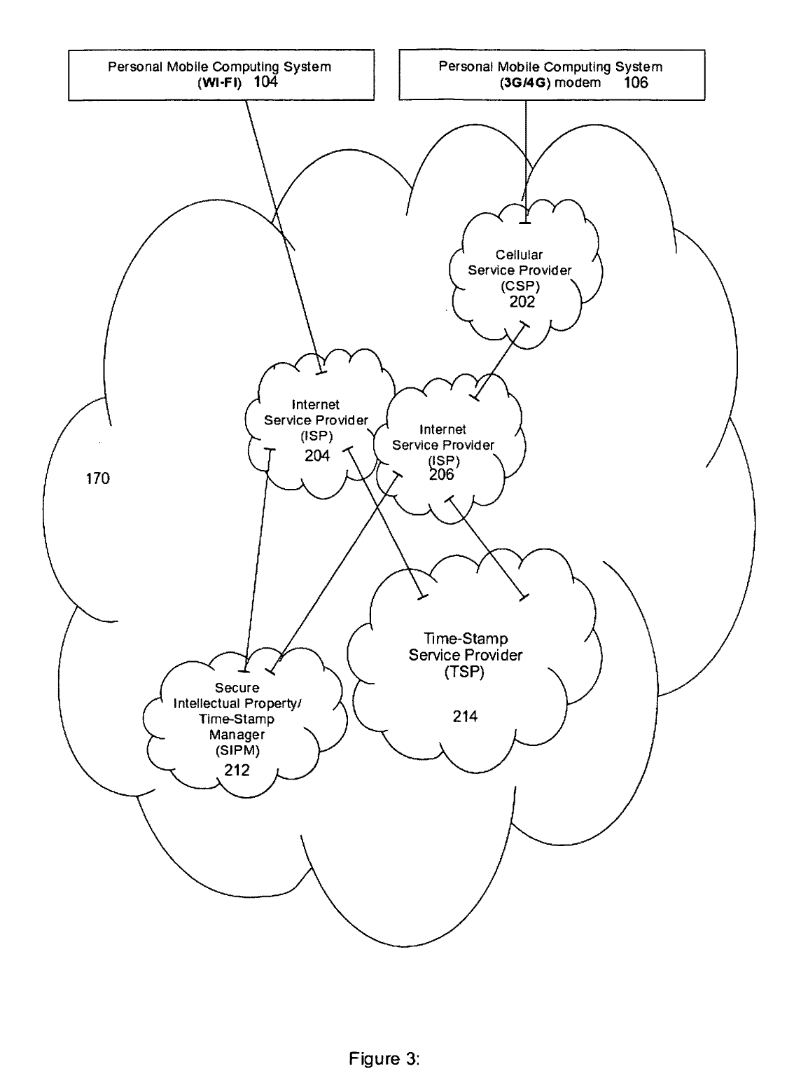

This message structure is then sent to the Surety, LLC Trusted Time Stamp service 214 to request a standard time-stamp token. FIG. 3 that is described below illustrates the relationship of the PMCS and the trusted time-stamp service with regard to the request for time-stamp and receipt of the time-stamp token.

The inventor's PMCS receives Surety's newly generated time-stamp token that he just requested. This time-stamp token is created as a cryptographic assurance of having established the temporal existence of the inventor's new intellectual property. This new token is then bound in the above IPWitness binding zip file-system for the convenient management of his intellectual property and his expertly witnessed time-stamp that proves that the inventor's new idea was conceived before all other revelations of the idea documented in the chalk talk and on the white board.

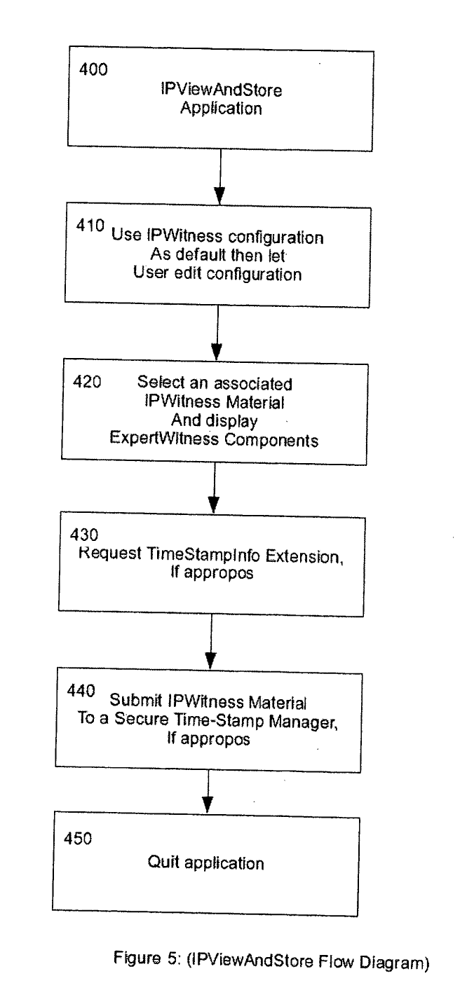

The inventor may, as outlined by FIG. 5 that is described below, securely record the inventor's expertly witnessed IPWitness binding zip file-system using the adjunct application, IPViewAndStore. This service provides a long-term archive of the expert witness of the intellectual property in coordination with the material that validates the original conception of the idea.

The user-managed, illustrative personal mobile computing system (PMCS) 100 shown in FIG. 2 is comprised of a number of illustrative subsystems, some in hardware and others in software which are defined and described herein. The interaction among the subsystems demonstrates how the personal mobile computing system manages system operation. The hardware components are referred to collectively as a Personal Mobile Computer (PMC) 103. The illustrative PMCS includes an array of components. Components in this illustrative embodiment include:
3G/4G modem 106—is selected from a family of devices based on International Telecommunications Union (ITU) standards used for cellular telephones.
API 160—the application programming interface is a collection of software interfaces which are designed to offer a standardized means for a program to manage PMCS 100 capabilities.
Audio 110—the device(s) for capturing (input) and emitting (output) sound.
Camera 108—device(s) integrated with electronic image signal processors used to digitally capture a digital facsimile (image), generally two-dimensional, of a viewed subject or record composite and S-video. Such devices are capable of producing still digital images of varying quality ranging from 3 mega-pixels to 12 mega-pixels. Some can record video images at a rate of as high as, for example, 30 frames/second.
NSC 170—a collection of networked services to which a PMCS 100 may interact.
Drivers 130—software modules used by the PMCS operating system 140 to manage and operate the various hardware devices of the PMC 103.
External I/O 122—wired and wireless connectivity via USB, HDMI, Bluetooth, and/or NFC (Near Field Communication) interfaces which allow the capture of digital facsimiles of intellectual property which have been generated on other devices, e.g., laptop, intelligent “pens” which capture and transmit audio and handwritten material, audio recorders, smart-phones. Wi-Fi 104 and 3G/4G 106 I/O could be considered in this category, but are purposefully singled out as extra-special I/O cases.
GPS 114—the receiving device on the PMC 103 that calculates its position using global positioning system (GPS) satellites orbiting the earth.
KP 120—a keypad or keyboard input device used to manipulate PMCS 100 functionality. Many types of PMCS offer virtual KP functionality via touch screen (TS) 118 functionality.
OS 140—the operating system software that defines and orchestrates much of the capability of the PMCS. The PMCS' OS 140 may be, for example Android, iOS4, Maemo, WebOS, or WP7. PMCS 100—is the exemplary personal mobile computing system that manages the functions for achieving the user-side of the illustrative methodology.
PMC 103—Personal Mobile Computer, the power-optimized computing device designed for embedding into personal mobile computing systems.
SD 116—typically consists of a combination of flash memory and removable micro-secure digital card (micro SD). Its purpose into provide file system storage on the PMCS 100.
TS 118—much of the input is used to manipulate PMCS UI 150, virtual KP, and simple drawing functionality comes via the touch screen.
UI 150—the user interface, often referred to as the graphical user interface (GUI), is a means of iconic-ally, visually, and tactilely allowing the PMCS user to efficiently interact with the computing system.
Wi-Fi 104—a trademark of the WI-FI Alliance that refers to a class of wireless local area network (WLAN) devices based on the IEEE 802.11 suite of standards. The PMCS 100 makes uses Wi-Fi 104 as one of the methods of interacting with the NSC 170.
2D/3D Graphics 112—
Optional Integrated Cryptography 102—

The interaction of these components is illustrated in the exemplary Personal Mobile Computing System (PMCS) of FIG. 2. The PMCS 100 in this illustrative implementation contains all of the other components except the NSC. The Wi-Fi 104 and/or the 3G/4G 106 elements provide a convenient means for the PMCS to communicate with the NSC 170. The devices and access to the devices are typical for a well-equipped personal computer and would be well-understood by those with ordinary skill in the art.

It should be understood that the devices illustrated in FIG. 2 are not all of those inherent in most PMCS, but they are those useful for implementing the methodology described herein, especially the KP 120, the Camera 108, the Audio 110, and the External I/O 122. A PMCS missing one or more of the elements identified above may still be well suited to practice an illustrative implementation. Video recording capability may not be a user's desired means of capturing a digital facsimile of the intellectual property, but is considered an important option for obtaining the digital facsimile of an intellectual property. The GPS unit 114, that cellular telephone providers use to fulfill the Federal Communications Commission (FCC) 911-emergency location mandate, is typically installed on a smart-phone. Therefore, the PMCS will likely have such a unit in case the user desires to bind the recording location to the recorded digital facsimile of the intellectual property. The NSC 170 contains the secure Time-Stamp service (214 of FIG. 3) which this methodology preferably utilizes. The NSC may also contain the service 212 that will securely manage the digital facsimile of an intellectual property and its associated secure time-stamp.

The NSC is further described in FIG. 3: Network Services Cloud (NSC). As mentioned above, the Network Services Cloud 170 provides the necessary service for requesting and receiving the secure Time-Stamp for protecting the digital facsimile of an intellectual property as proposed by this methodology. FIG. 3 depicts the Network Services Cloud (NSC) showing network services utilized by the PMCS. As shown in FIG. 3, the network services utilized herein include:
3G/4G as described above in conjunction with FIG. 2.
CSP 202—the Cellular Service Provider is the agent that manages connectivity of the PMCS 170 over the 3G/4 G communication device 106.
ISP 204—the Internet Service Provider is the networking agent to which the PMCS is connected via the protocols (TCP/IP) over the Wi-Fi communications access device 104 or the CSP 202.
NSC 170—the Network Services Cloud previously described.
SIPM 212—the Secure Intellectual property/Time-Stamp Manager is largely a Cloud service that provides a secure storage vault for managing the digital facsimile of an intellectual property with its associated secure time-stamp.
TSP 214—the secure Time-Stamp Service Provider is that which responds to requests for a standardized cryptographic Time-Stamp to cryptographically bind the cryptographic imprint of a digital facsimile of an intellectual property.
Wi-Fi 104—as has been previously described.

The communication from the PMCS 100 to the NSC 170 is managed through either the Wi-Fi 104 or 3G/4G 106 connections. Typically the Wi-Fi 104 connection is preferred due to speed. But, Wi-Fi connectivity is not always available so that 3G/4G 106 cellular connection may need to be utilized. In either case, a request for a time-stamp will be initiated to a Trusted Time-Stamp Service Provider (TSP) 214. The request will typically be resolved and returned to the PMCS 100 for storage and association with a digital facsimile of the intellectual property. In the event that the responsible party for the association chooses to further protect this association, both a digital facsimile of the intellectual property and its associated Time-Stamp can be securely managed on NSC service SIPM 212.

### Exemplary Embodiment

In an illustrative implementation, IPWitness, may be an Android application implementing the methodology described herein. As suggested earlier the various components of IPWitness include:
PMCS 100—is illustratively implemented using a Motorola Droid X smart-phone on which the IPWitness application is installed, but, for example, it is expected that any other Android-managed device will work with little or no additional effort.
PMC 103—Texas Instruments OMAP 3630 processor with the support circuitry to comprise the whole hardware implementation of the PMCS 100. ARM is the predominant processor on most smart-phones. No special instructions in the OMAP 3630 are required therefore most processor solutions will suffice.
OS 140—Android 2.2 (Froyo) or a later release manages the installed IPWitness application. Again, use of Android 2.2 or later is not mandated. Earlier versions of Android may well work.
Camera 108—8 mega-pixel still frame to capture a digital image of an intellectual property.
Wi-Fi 104—the Motorola Droid X allows 802.11n connectivity to a wireless point of presence, including ad hoc mode connectivity as an option. An IEEE 802.11n is not required. As will be apparent to those skilled in the art, a wide variety of Wi-Fi devices should suffice.

3G/4G 106—the Motorola Droid X contains cellular telephonic capacity which allows network connectivity. The IPWitness application of this illustrative implementation will use this connectivity only when Wi-Fi connectivity cannot be established.
SD 116—Secure Digital card is an illustrative recording medium on the PMCS. This medium is often removable and is usually implemented as a flash memory device. Presently, the storage capacity of an SD typically ranges from 512 megabytes to 32 gigabytes.
External I/O 122—the Motorola Droid X has a mini-USB 2.0 connector that allows it to connect to other devices with USB connections. As well, the Droid X has Bluetooth, version 2.1, capability for external wireless communications. External I/O interfaces could be used to capture the USB 2.0 output of such devices as the Livescribe SmartPen or the NuTech Spy Pen Video Recorder. Such devices offer access to their local file-system to acquire the information they have recorded. Of course, use of such devices may well be moot and redundant since the PMCS possesses much of these capabilities already.
UI 150—Android 2.2 to present IPWitness to the user of the PMCS.
API 160—the Android 2.2 API for the Java programming to create the IPWitness application to be run on the Dalvik Java Virtual Machine (JVM) for Android applications. The Android API is readily programmed using the Android plug-in tool using the Eclipse.org IDE. The plug-in and the API offer a high-end programming tool for managing the Camera 108, TS 118, SD 116, Wi-Fi 104, 3G/4G 106, and KP 120 devices.
TSP 214—Surety, LLC will resolve the requests for each time-stamp of the digital facsimile of an intellectual property that has been captured by the PMCS Camera 108 then transmitted over the Wi-Fi 104 or 3G/4G 106 connection to the NSC in which the Surety, LLC TSP 214 resides. This will require that the Surety, LLC Java software development kit (SDK) for time-stamp requests be configured with the IPWitness application. The use of this SDK will require that the user be licensed by Surety, LLC to make time-stamp requests.
The cryptographic imprint will be composed of the SHA-256 and RIPEMD-160 message digests as applied to the digital image of the intellectual property photographed by the PMCS Camera 108. This imprint will be sent to the Surety, LLC TSP 214 via the Surety SDK for time-stamp requests. These cryptographic message digests will be provided by the CyaSSL Java SSL JCE provider for embedded software security as offered by Sawtooth Consulting LTD. The speed and size of this solution offers an optimal solution for the Android platform.
The security classes found in the Apache.org Harmony class library are used to produce an optimal solution for access to the classes necessary to manage the coding and decoding of ASN.1 structures proposed by the standards that describe secure Time-Stamp management.
The IPWitness application will use the Surety, LLC SDK code to receive the resolved time-stamp as sent by a Surety trusted time-stamp service.
The IPWitness application will then loosely bind the digital facsimile of the intellectual property to the received time-stamp by creating a ZIP-package of these entities. ZIP is a popular, widely-used archive format. Like other archives, ZIP files are data containers, frequently tried as a special file system. They store one or several files in the compressed form and optionally encrypted for privacy protection. This ZIP-package will then be recorded on the PMCS SD 116 for subsequent use.

A series of application flow diagrams are described below. These diagrams not only provide a graphic explanation of IPWitness as an implementation of this exemplary implementation, they also show a companion application to IPWitness labeled as IPViewAndStore. As the name implies, IPViewAndStore shows the content of the associated time-stamp with its digital facsimile of the captured intellectual property. In an illustrative implementation IPWitness and IPViewAndStore may be integrated into a single application.

The illustrative flowchart in FIG. 4a (IPWitness 300) is largely self-explanatory. Flowchart steps 302, 304 and 306 show the installation and configuration of IPWitness. Steps 308 and 310 of this diagram also allude to the event management loop that is integrated into IPWitness.

Exiting this loop will transfer control to B 350 on FIG. 4b.

This subprocess shows that any combination of the keypad 120, camera 108, audio 110, or video 110 devices can each be attached as an input stream of digital facsimiles of the intellectual property for creation of the complete digital facsimile of the intellectual property.
Step 350 begins the process by determining if the reason for exiting from the previous subprocess (300 in FIG. 4a) was caused by the PMCS OS 140, if so then the subprocess proceeds to Step 352.
   If the reason for exiting from the previous subprocess (300 in FIG. 4a) was not caused by a device interrupt 354 then an error event is logged 356, then proceed to Step C352 to finish and exit from the subprocess.
   If the reason for exiting from the previous subprocess (300 in FIG. 4a) was caused by a device interrupt then the subprocess proceeds to Step 358.
Step C 352 performs the process clean-up phase and then exits the process.
Step 358 controls the process of adding an InputStream from a device to a List of captured InputStreams for subsequent processing.
   If there are more, active, device, listeners 360 and the user desires to process all listeners the process proceeds to Step A 312 of FIG. 4a to wait until another device or system event occurs otherwise the process proceeds to Step 314.
Step 314 controls the process of calculating the cryptographic imprint of digital facsimiles of the intellectual property using the List of InputStream from all of the sources from which the digital facsimiles are collected. In addition the variously desired intellectual property attribute extensions are bound into this same cryptographic imprint, in toto, and then proceed to Step 316.
Step 316 performs the process of establishing the authorization of using the Trusted Time-stamp Service 214 of choice then proceeding to Step 318.
Step 318 controls the process of packaging the singular cryptographic imprint as a request for a cryptographic time-stamp of the imprint then proceed to Step 320.
Step 320 manages the synchronous receipt of the requested standardized time-stamp structure from the trusted time-stamp service 214 then proceeds to Step 322.
Step 322 manages the process of conveniently packaging and associating the new standards-based time-stamp with the digital facsimiles of the captured intellectual property. IPWitness is designed in this illustrative implementation to individually record each of the captured digital facsimiles of the intellectual property along with the desired intellectual property attribute extensions and a manifest that lists these data in a loosely binding package followed by the recorded cryptographic time-stamp or in a relational database capability that is integral to most PMCS 100 devices, especially the Android. At the same time this binding package is recorded in the SD 116 storage system in the PMCS. One of the simplest forms of binding package could be that of the typical zip-package which consists of a portable, compressed file-system. A zip file-system is a data compression and archive format that contains one or more files for conveniently, loosely binding files together. The zip-package has become a common means of file management. The zip-package is a typical, convenient means of exchanging files among computing system users.

FIG. 5 (Flow Diagram of IPViewAndStore) is a flow-diagram that provides a simplified flow of a companion application which supplements IPWitness as IPViewAndStore. IPViewAndStore 300 allows a user of the PMCS to visit an IPWitness binding package and display the authenticity and content of the binding package. IPViewAndStore also allows the user of the PMCS to optionally transmit a selected binding package to a secure intellectual property time-stamp manager (SIPM) 212. The steps of this process include steps 410, 420, 430, 440 and 450, wherein:
Step 410 establishes the configuration from the above companion application, IPWitness, as the default configuration for IPViewAndStore. Then proceed to Step 420.
Step 420 select an IPWitness binding package which contains the digital facsimiles of an intellectual property along with the associated standardized time-stamp as described in FIGS. 4a and 4b. Using the Expert Witness, open software API display the expert witness components of the standardized time-stamp contained in the binding package. Proceed to Step 430.
Step 430 controls the process of determining if the standardized time-stamp is an ISO/IEC 18014-3 linked token time-stamp which has been extended by it public witness attribute. If so, then the time-stamp in the binding package is upgraded with the public witness attribute. Proceed to Step 440.
Step 440 determines if the binding package is a candidate for the Secure Time-Stamp Manager (SIPM) 212. If so then the binding package is sent to the Secure Time-Stamp Manager for its services. Proceed to Step 450.
Step 450 closes the application processing and quits as a running process.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method for generating digital evidence relating to the creation of a work product of a user comprising the steps of:
capturing from at least one input source digital evidence relating to the work product using a personal mobile computing device;
composing a digital representation of the work product from said at least one input source;
generating a cryptographic imprint of the digital representation of the work product identifying at least time-related information related to the created work product.

2. A method according to claim 1, wherein said step of generating a cryptographic imprint includes the step of generating at least one cryptographic message digest of the composed digital representation of the work product.

3. A method according to claim 1 further including the steps of requesting a standards-based time-stamp, and sending the request to a trusted time-stamp authority using the cryptographic imprint of the digital representation of the work product.

4. A method according to claim 1, wherein a digital camera embodied in the mobile computing device is used to capture a digital facsimile of the work product.

5. A method according to claim 1, further including the step of digitally capturing an oral rendition of the work product.

6. A method according to claim 1 including the steps of capturing both a photographic and audio rendition of the work product.

7. A method according to claim 1, wherein the step of generating a cryptographic imprint includes the step of generating a cryptographic imprint comprised of multiple cryptographic message digest functions calculated on the personal mobile computing device which captured the digital representation of the work product.

8. A method according to claim 1 further including the steps of:
acquiring at least one identity related to the work product;
encoding said at one least one identity; and
associating said at least one identity with the digital representation of the work product.

9. A method according to claim 8, wherein said at least one identity includes an inventor of the work product.

10. A method according to claim 8, wherein said at least one identity includes an owner of the work product.

11. A method according to claim 8, wherein said at least one identity includes a requester of proof of time-related information regarding the work product.

12. A method according to claim 1, wherein the personal mobile computing device includes a global positioning system (GPS) that generates the coordinates of the personal mobile computing system device further including the steps of:
capturing the coordinates of the personal mobile computing device using the global positioning system (GPS) coordinates of the personal mobile computing device; and
encoding the coordinates into an attribute extension object.

13. A method according to claim 12, further including the step of combining the encoded coordinates with the composed digital representation of the work product before generating the cryptographic imprint.

14. A method according to claim 3, further including the step of receiving a trusted time stamp from the time-stamp authority by the personal mobile computing device for association with a digital representation of the work product.

15. A method for generating digital evidence of a created work product comprising the steps of:
capturing at least image data that is a digital facsimile of a created work product from a camera of a personal mobile computing device;
generating a digital facsimile of the created work product using at least the image data captured by said personal mobile computing device;
acquiring at least one identity related to the created work product; and
generating a cryptographic imprint of the digital facsimile of the created work product, an identity related to the created work product and time-related information regarding the work product using at least one cryptographic message digest function.

16. A method according to claim 15, further including the steps of requesting a standards-based time-stamp, and sending the request to a trusted time-stamp authority using the cryptographic imprint of the digital representation of the work product.

17. A method according to claim 15, further including the step of digitally capturing an oral description of the work product.

18. A method according to claim 15, wherein the step of generating a cryptographic imprint includes the step of generating a cryptographic imprint comprised of multiple cryptographic message digest functions calculated on the personal mobile computing device which captured the digital representation of the work product.

19. A method according to claim 15, wherein said at least one identity includes an inventor of the work product.

20. A method according to claim 15, wherein said at least one identity includes an owner of the work product.

21. A method according to claim 15, wherein said at least one identity includes a requester of proof of time-related information regarding the work product.

22. A method according to claim 15, wherein the personal mobile computing device includes a global positioning system (GPS) that generates the coordinates of the personal mobile computing system device further including the steps of:
capturing the coordinates of the personal mobile computing system using the global positioning system (GPS) coordinates of the personal mobile computing device; and
encoding the coordinates into an attribute extension object.

23. A method according to claim 22, further including the step of combining the encoded coordinates with the composed digital representation of the work product before generating the cryptographic imprint.

24. A method according to claim 15, further including the step of receiving a trusted time stamp from the time-stamp authority by the personal mobile computing device for association with a digital representation of the work product.

25. A machine-readable recording medium having a program recorded thereon for causing a computer system in a personal mobile computing device to execute a method for generating digital evidence relating to the creation of a work product of a user, said program causing the computer system to execute the steps of:
receiving from at least one input source digital evidence relating to the work product using a personal mobile computing device;
composing a digital representation of the work product from said at least one input source; and
generating a cryptographic imprint of the digital representation of the work product identifying at least time-related information related to the created work product.

26. A recording medium according to claim 25, wherein said step of generating a cryptographic imprint includes the step of generating at least one cryptographic message digest of the composed digital representation of the work product.

27. A recording medium according to claim 25, wherein the computer system executes the further steps of requesting a standards-based time-stamp; and sending the request to a trusted time-stamp authority using the cryptographic imprint of the digital representation of the work product.

28. A recording medium according to claim 25, wherein the receiving step including the steps of receiving both a photographic and audio depiction of the work product.

29. A recording medium according to claim 25, wherein the step of generating a cryptographic imprint includes the step of generating a cryptographic imprint comprised of multiple cryptographic message digest functions calculated on the personal mobile computing device which captured the digital representation of the work product.

30. A recording medium according to claim 25, wherein the personal mobile computing device includes a global positioning system (GPS) that generates the coordinates of the personal mobile computing system device, wherein the computer system further performs the steps of:
receiving the coordinates of the personal mobile computing system using the global positioning system (GPS) coordinates of the personal mobile computing device; and
encoding the coordinates into an attribute extension object.

31. A machine-readable recording medium having a program recorded thereon for causing a computer system in a personal mobile computing device to execute a method for generating digital evidence relating to the creation of a work product of a user, said program causing the computer system to execute the steps of:
receiving at least image data that is a digital facsimile of a created work product from a camera of a personal mobile computing device;
generating a digital facsimile of the created work product using at least the image data captured by said personal mobile computing device;
acquiring at least one identity related to the created work product; and
generating a cryptographic imprint of the digital facsimile of the created work product, an identity related to the created work product and time-related information regarding the work product using cryptographic message digest functions.

32. A personal mobile computer system for generating digital evidence relating to the creation of a work product of a user comprising:
a digital camera for capturing at least image data that is a digital facsimile of a created work product;
an input device for inputting at least one identity related to the created work product; and
a processing subsystem configured to generate a digital facsimile of the created work product using at least the image data captured by said digital camera and said at least one identity related to the created work product; and generating a cryptographic imprint of the digital facsimile of the created work product, said at least identity related to the created work product and time-related information regarding the work product using at least one cryptographic message digest function.

33. A personal mobile computer system according to claim 33, further including an output subsystem, said processing subsystem being configured to send a request via said output subsystem requesting a standards-based time-stamp, and sending the request to a trusted time-stamp authority using the cryptographic imprint of the digital representation of the work product.

34. A personal mobile computer system according to claim 33, further including an audio recorder for digitally capturing an oral depiction of the work product.

35. A personal mobile computer system according to claim 33, wherein said step of generating a cryptographic imprint includes generating a cryptographic imprint comprised of multiple cryptographic message digest functions.

36. A personal mobile computer system according to claim 33, wherein said at least one identity includes an inventor of the work product.

37. A personal mobile computer system according to claim 33, wherein said at least one identity includes an owner of the work product.

38. A personal mobile computer system according to claim 33, wherein said at least one identity includes a requester of proof of time-related information regarding the work product.

39. A personal mobile computer system according to claim 33 further including:
a global positioning system (GPS) that generates the coordinates of the personal mobile computing system device, said processing system being configured to capture the coordinates of the personal mobile computing system using the global positioning system (GPS) coordinates of the personal mobile computing device; and
encode the coordinates into an attribute extension object.

40. A personal mobile computer system according to claim 39, further including the step of combining the encoded coordinates with the composed digital representation of the work product before generating the cryptographic imprint.

41. A personal mobile computer system according to claim 33, further including a receiver for receiving a trusted time stamp from a time-stamp authority for association with a digital representation of the work product.
